(19) United States
(12) Patent Application Publication
(10) Pub. No.: US 2007/0170292 A1
(43) Pub. Date: Jul. 26, 2007

(54) Cone crusher

(75) Inventor: Christopher William Wagstaffe, Derbyshire (GB)

Correspondence Address: KIRTON AND MCCONKIE, 60 EAST SOUTH TEMPLE,, SUITE 1800, SALT LAKE CITY, UT, 84111, US

(73) Assignee: EXTEC SCREENS & CRUSHERS LIMITED, Derbyshire (GB)

(21) Appl. No.: 10/598,393

(22) PCT Filed: Feb. 24, 2005
(86) PCT No.: PCT/GB05/00684

§ 371 Date: Jan. 4, 2007

(30) Foreign Application Priority Data
Feb. 26, 2004 (GB) 0404263.6
Mar. 4, 2004 (GB) 0404879.9

(51) Int. Cl. B02C 2/04

(52) U.S. Cl. 241/214

(57) ABSTRACT

A cone crusher is disclosed with a bowl having a concave liner, a head having a mantle and which is capable of carrying out gyratory movement within the bowl so that the concave liner and the mantle define a generally annular crushing space and cooperate to exert a crushing action on crushable material in such space, and a drive train coupled with the head and operative to apply gyratory movement thereto. The drive train includes an upright drive shaft, an eccentric mounted on, and arranged to be driven by the drive shaft. The head is mounted on the eccentric so that the head is driven to carry out gyratory movement within the bowl. A drive motor is coupled with a lower end of the drive shaft to present minimum obstacle to direct downward gravity discharge of crushed material from the crushing space defined between the concave liner and the mantle.

This invention relates to a cone crusher for crushable material and which comprises a stationary bowl having a concave liner, a head having a mantle which is capable of carrying out gyratory movement within the bowl so that the concave liner and the mantle cooperate to exert crushing action on material therebetween, and a drive train coupled with the head to apply gyratory movement thereto.

As is well known in the art, a cone crusher usually has a vertically mounted eccentric bearing on which the head is mounted for gyratory movement. A first typical known example is disclosed in U.S. Pat. No. 1,791,584.

Up to now, most cone crushers which are manufactured are of the static installation type, and current drive trains to drive the eccentric bearing usually include a horizontal layshaft which transmits rotation to the eccentric bearing via a bevel gearset (see e.g. U.S. Pat. No. 3,372,881), and which is of substantial radial extent measured outwardly of the axis of the eccentric.

It is also known from U.S. Pat. No. 5,115,991 to transmit drive from a suitable prime mover direct to the lower end of the eccentric bearing via a belt drive.

However, the power and torque which can be transmitted via a belt drive is somewhat limited, and given the very high torque input requirement of a cone crusher, the torque input from a belt drive to the input shaft is often not thought to be sufficient for the purpose.

Furthermore, given that the crushed material output from a cone crusher falls downwardly under gravity from the generally annular crushing space defmed between the mantle and the concave liner, it is usually necessary to divert the output laterally so as to by-pass the drive input to the lower end of the eccentric bearing, and which gives rise, in practice, to frequent blockages in the output path which have to be unjammed, and which requires repeated interruption in the operation of the crusher. This reduces production efficiency, and requires constant monitoring which is a wasteful use of skilled labour.

This lateral diversion is necessary, bearing in mind the substantial lateral profile presented by the bevel gear input from the horizontal lay shaft to the upright drive shaft in the first known arrangement, and a similar substantial lateral profile (radially of the axis of the drive shaft) in the case of the direct belt/pulley drive assembly to the lower end of the drive shaft in the second known arrangement.

The present invention seeks to provide an improved drive train coupled to the eccentric bearing of a cone crusher, which enables ready input of sufficient torque to rotate the head and which takes up minimum lateral space (measured radially outwardly of the axis of the shaft) below the main shaft so as not to present any significant obstacle to direct downward discharge of crushed material from the annular crushing space between the mantle and the liner, i.e. so that it is no longer necessary to divert the output path laterally of the lower end of the eccentric bearing.

According to the invention there is provided a cone crusher which comprises:
a bowl having a concave liner;
a head having a mantle and which is capable of carrying out gyratory movement within the bowl so that the concave liner and the mantle define a generally annular crushing space therebetween and cooperate to exert a crushing action on crushable material in the said space; and
a drive train coupled with the head and operative to apply gyratory movement thereto; in which the drive train comprises:
an upright drive shaft;
an eccentric mounted on, and arranged to be driven by the drive shaft, said head being mounted on the eccentric in such a way that the head is driven to carry out gyratory movement within the bowl; and
a drive motor coupled with the lower end of the drive shaft, said motor having a small lateral extent, measured radially outwardly of the axis of the drive shaft, so as to present minimum obstacle to direct downward gravity discharge of crushed material from the crushing space defined between the concave liner and the mantle.

Preferably, the upright drive shaft is mounted for rotation internally of a main shaft securely located in the frame of the crusher, and on which the rotating head assembly is centred.

The motor preferably has a lateral extent which is less than the radial extent of the eccentric, whereby a clear, unobstructed downward annular path of substantial cross-sectional area is defined for gravity discharge of crushed material.

The motor may be a hydraulic motor with a high power to weight/volume ratio, though it is envisaged that some electric motors also may be suitable.

Conveniently, the eccentric is rotated about the axis of the main shaft, supported by a thrust bearing and a radial bearing, and the head is arranged to revolve about a second offset axis, by being carried on the outer bearing faces of the eccentric, and supported by a thrust bearing and a radial bearing.

To provide for adjustment of the crushing gap between the concave liner and the mantle, the bowl may be upwardly/downwardly adjusted relative to the frame. This may be obtained by providing an internally threaded adjustment ring within which an external thread of the bowl engages, and by carrying out relative rotation therebetween.

By providing a drive motor immediately below the lower end of the drive shaft, and preferably coupled directly therewith, and by virtue of the small radial extent of the motor, sufficient torque to drive the head can be obtained, especially with preferred use of a hydraulic motor, while leaving unobstructed a substantial cross-sectional area of annular passage for gravity discharge of crushed material.

Such a compact assembly is particularly advantageous to one preferred application of the invention to a mobile crusher plant.

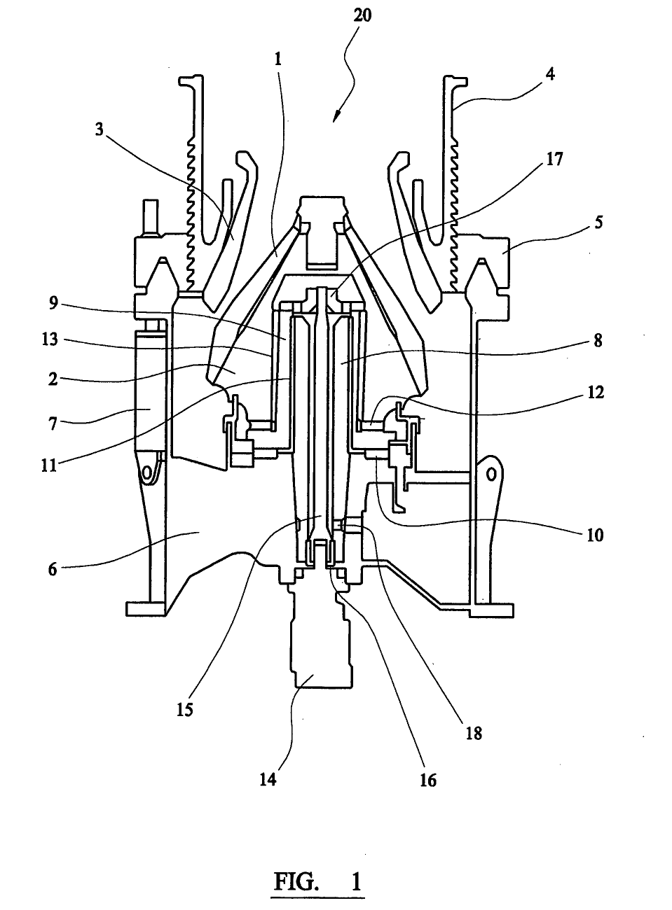

A preferred embodiment of cone crusher according to the invention will now be described in detail, by way of example only, with reference to FIG. 1 of the accompanying drawings, which is a vertical sectional illustration.

Referring to the drawing, a cone crusher according to the invention is designated generally by reference 20 and comprises a stationary bowl 4 having a concave liner 3 and which is mounted on the frame 6 of the crusher via an internally threaded adjustment ring 5, with which an external thread of the bowl 4 engages.

A gyratory head 2 has a mantle 1 which protects the head from abrasive wear, and which is capable of carrying out gyratory movement within the bowl 4 so that the concave liner 3 and the mantle 1 define a generally annular crushing space, and cooperate to exert a crushing action on crushable material in such space.

A drive train is coupled with the head 2, which applies gyratory movement thereto, and which will be described in more detail below.

The action of crushing occurs between hard, wear-resistant components, namely the mantle 1 which protects the head 2, and the concave liner 3 which protects the bowl 4. Adjustment of the output of the crusher is achieved by upwardly or downwardly adjusting the height of the bowl 4, by relative rotation between the bowl 4 and the adjusting ring 5, which opens or closes the gap between mantle 1 and liner 3.

The upper part of the assembly is located on the frame 6 of the crusher, and the two parts are held together by hydraulic cylinders 7 positioned at intervals around the periphery.

The drive train which applies gyratory movement to the head will now be described in detail. Essentially, there is an upright drive shaft 15, and an eccentric 9 mounted on, and arranged to be driven by the drive shaft 15. The head 2 is mounted on the eccentric 9 in such a way that the head is driven to carry out gyratory movement within the bowl 4.

A drive motor 14 is coupled directly with the lower end of the drive shaft 15, and as can be seen from the drawing the motor and its housing has a small lateral radial extent, measured radially outwardly of the axis of the drive shaft 15, so as to present minimal obstacle to direct downward gravity discharge of crushed material from the crushing space defined between the concave liner 3 and the mantle 1.

The upright drive shaft 15 is mounted for rotation internally of a main shaft 8 which is secured located in the frame 6 of the crusher, and on which the entire rotating head assembly 2, 9 is centred.

As can be seen in the drawing, the motor 14 has a lateral extent which is less than the radial extent of the eccentric 9, whereby a clear, unobstructed downward annular path of substantial cross-sectional area is defined, for gravity discharge of crushed material from the space between the bowl 4 and the head 2. However, in that the actual discharge area of the crushed material is limited by the diameter of the head 2, it is only necessary for the motor 14 to have a smaller lateral extent than the radial extent of the head, so that the motor does not impede gravity discharge of the crushed material. It follows therefore that a smaller design of head 12 may be provided from that illustrated, and that motor 14 will still not present any obstacle to gravity discharge of the crushed material.

The motor 14 is a hydraulic motor with a high power to weight/volume ratio, though it is envisaged that some types of electric motor also may be suitable.

The eccentric 9 is rotated about the axis of the main shaft 15, supported by thrust bearing 10 and radial bearing 11, and the head 2 revolves about a second offset axis, by being carried on the outer bearing faces of the eccentric 9 and supported by trust bearing 12 and radial bearing 13. This arrangement provides required gyratory action between the crusher head 2 and the bowl 4.

The eccentric 9 is therefore rotated about the axis of the main shaft 8, driven by the motor 14 via drive shaft 15 which is located at its lower end by bearing 16. Final transmission of drive from shaft 15 to the eccentric 9 takes place via drive flange 17. The connections between the motor 14, drive shaft 15 and drive flange 17 preferably include splined joints to allow for axial adjustments. The drive flange 17 may incorporate elastomeric shock absorbing elements to reduce shock loads which may be transmitted to the drive shaft and the drive motor.

Lubricating oil flowing from the radial bearings may be evacuated by means of drain holes in the drive flange 17, through the bore of the main shaft 8 and via gallery 18.

1. A cone crusher which comprises;
a bowl having a concave liner;
a head having a mantle and which is capable of carrying out gyratory movement within the bowl so that the concave liner and the mantle define a generally annular crushing space and cooperate to exert a crushing action on crushable material in such space; and
a drive train coupled with the head and operative to apply gyratory movement thereto;
in which the drive train comprises:
an upright drive shaft;
an eccentric mounted on, and arranged to be driven by the drive shaft, said head being mounted on the eccentric in such a way that the head is driven to carry out gyratory movement within the bowl; and
a drive motor coupled with a lower end of the drive shaft, said motor having a small lateral extent, measured radially outwardly of the axis of the drive shaft, so as to present minimum obstacle to direct downward gravity discharge of crushed material from the crushing space defined between the concave liner and the mantle:
characterized in that the upright drive shaft is mounted for rotation internally of a main shaft securely located in the frame of the crusher and on which the rotating head assembly is centred.

2. A cone crusher according to claim 1, in which the motor has a lateral extent which is less than the radial extent of the eccentric, whereby a clear, unobstructed downward annular path of substantial cross-sectional area is defined for gravity discharge of crushed material.

3. (canceled)

4. A cone crusher according to claim 1, in which the motor has a lateral extent which is less than the radial extent of the head.

5. A cone crusher according to claim 1, in which the motor is a hydraulic motor or an electric motor.

6. A cone crusher according to claim 1, in which the eccentric is rotatable about the axis of the main shaft, supported by thrust bearing and radial bearing, and the head is capable of revolving about a second offset axis, by being carried on the outer bearing faces of the eccentric and supported by a thrust bearing and radial bearing.

7. A cone crusher according to claim 1, in which the crushing gap between the concave liner and the mantle is adjustable, by upward/downward adjustment of the bowl relative to the frame.

8. A cone crusher according to claim 7, in which the bowl is externally threaded, and is mounted on the frame via an internally threaded adjustment ring, whereby relative rotation therebetween provides height adjustment of the bowl.

9. A cone crusher according to claim 1, in which the drive motor is coupled directly with the lower end of the drive shaft.

10. A cone crusher according to any one of the preceding claims claim 1, and forming part of a mobile crusher plant.
